(19) United States
(12) Patent Application Publication
(10) Pub. No.: US 2014/0279866 A1
(43) Pub. Date: Sep. 18, 2014

(54) CONTACT DATA ENGINE

(71) Applicants: Lizzabeth Brown, Johnston, RI (US); Vincent Brown, Johnston, RI (US)

(72) Inventors: Lizzabeth Brown, Johnston, RI (US); Vincent Brown, Johnston, RI (US)

(21) Appl. No.: 14/206,216

(22) Filed: Mar. 12, 2014

Related U.S. Application Data
(60) Provisional application No. 61/779,794, filed on Mar. 13, 2013.
(60) Provisional application No. 61/870,262, filed on Aug. 27, 2013.

(51) Int. Cl. G06F 17/30

(52) U.S. Cl. CPC G06F 17/30289
USPC 707/609

(57) ABSTRACT

A contact data management system in a networked computers environment and computer-implemented method thereof, is disclosed. The system and method includes a data storage, a processor, and a program memory. A user interface is provided and configured to display and input a plurality of cards having contact information. The user interface is user interface logic operative to cause the processor and memory to display the user interface for a user. A database is configured to store and retrieve cards on the data storage. The database has logic operative to cause the processor and memory to create, read, update and delete contact information in the data storage. Each card includes a Card Owner field, designating the owner of the card. Each card also includes one or more relationships with other cards in the database.

### CROSS-REFERENCE TO RELATED APPLICATION

This patent document claims priority to earlier filed U.S. Provisional Patent Application No. 61/779,794, filed Mar. 13, 2013, and U.S. Provisional Patent Application No. 61/870,262, filed Aug. 27, 2013, the entire contents of which are incorporated herein by reference.

### BACKGROUND OF THE INVENTION

1. Technical Field

The present patent document relates generally to contact data management and more particularly to a method and system to propagate and maintain relationship links for contact data throughout a network or businesses and people.

2. Background of the Related Art

Computer systems and databases optimized for contact management that operate in a private networked environment suffer from the disadvantage that the contact information is not easily shared. Furthermore, these prior art systems do not maintain the relationship link between the contacts, thus not fully utilizing the contact data.

As shown in FIG. 1, a prior art method of sharing contact data is shown, such as Microsoft Outlook and Exchange products and Lotus Notes. As people become established in a particular field they develop a network of people with whom they regularly do business. When/if they change their contact information due to change of job, residence or other reasons it is very difficult if not impossible to easily notify all those who might have their business card. Typically, their network information is tied to a proprietary system owned by the company for which they work and is not transferrable to another system.

Social network-style solutions to contact management, such as LinkedIn and AngiesList.com, have the additional disadvantage of becoming cluttered with comments and ratings.

Accordingly, there is a perceived need in the prior art of a method and system to manage contact data that provides for more fluid sharing of contact data between businesses and individuals and maintains the relationship link between contacts.

### SUMMARY OF THE INVENTION

The present invention solves the problems of the prior art by providing a contact data management system and method that allows people who maintain a business card or business contact information to easily update, maintain and propagate that information when/if it changes. Also, the method and system described herein allows such people to easily propagate any changes to their network of trusted business relations. Because of the nature of the data storage, propagation of this information is made possible across multiple computer operating systems and software environments.

### BRIEF DESCRIPTION OF THE DRAWINGS

These and other features, aspects, and advantages of the present invention will become better understood with reference to the following description, appended claims, and accompanying drawings where:

FIG. 1 is a prior art representation for a method of distributing contact information;

FIG. 2 is an illustration of contact data being propagated between users;

FIG. 3 is an illustration of an internal data structure of the contact data engine;

FIG. 4a is an illustration of a collection of card illustrating tagging the cards;

FIG. 4b is an illustration of a screen for searching for a contact via tags;

FIG. 4c is an illustration of an internal data structure of relationship between contact data and tags;

FIG. 5 is an illustration of showing editing the contact information of a card;

FIG. 6 is an illustration showing a user claiming ownership of a card;

FIG. 7 is an illustration showing a user adding a card to their collection;

FIG. 8 is an illustration showing a user's collection of cards;

FIG. 9 is an illustration of a user sharing a card with another user;

FIG. 10 is an illustration showing a step of a user selecting cards to be shared;

FIG. 11 is an illustration showing a step of a user entering a recipient's email address to facilitate sharing of cards;

FIG. 12 is an illustration of a recipient logging into the system and seeing a notification that cards have been shared to them;

FIG. 13 is an illustration of a recipient viewing a screen to select whether to accept or decline a shared card;

FIG. 14 is an illustration showing a user adding a relationship to cards in their collection;

FIG. 15 is an illustration showing a user searching for cards in their collection and other searchable cards;

FIG. 16 is an illustration showing a screen where a user can manually create a new card and enter contact information;

FIG. 17 is an illustration showing a screen where a user can create a group;

FIG. 18 is an illustration showing a screen where a user can enter a name for the group;

FIG. 19 is an illustration showing a screen where a user may add cards to a group;

FIG. 20 is an illustration showing a screen where a user may view only cards in a particular group;

FIG. 21 is an illustration showing a screen where a user may create a card for a person that does not have an account in the system; and

FIG. 22 is an illustration showing a screen where a user my send an invitation to a person that does not have an account in the system.

### DESCRIPTION OF THE PREFERRED EMBODIMENT

Referring now to FIG. 2, and as will be more fully described below, an illustration of the method and system of propagating contact data between users is shown. The method and system, also called Busidex, is a cross-platform business card/contact information engine which allows users to easily update, maintain and share their business card data. The data repository is available via the internet and mobile devices. The following diagrams and charts describe the internal structure and behaviors of the system. Contact data is propagated through a Busidex Data Service

It should be understood that the present invention may be employed in any type of operating system. The present invention may be implemented in any type of software code using any language and can run on any type of computer hardware or networked computer hardware, including virtual machines. The computer hardware, virtual or physical, generally includes a processor, a program memory, and a data storage. The computer hardware may be networked, wired and wirelessly, to other computer hardware and accessible via other electronic devices, such as smartphones, PDA's and the like.

Referring to FIG. 3, the contact data, or card, is the central data structure and has attributes that describe contact information. One and only one instance of a card exists in the system at any given time. References to cards are made discoverable to and shared with users through Busidex Data Services. Cards may be edited by the Card Owner or, if Card Owner does not exist, the User that uploaded the card into the Busidex Data Services. Cards have a number of different elements, including one or more addresses, phone numbers, and/or tags. The central data structure is preferably stored as in a relational database, where relations may be maintained between the cards and card owners and users of the system. No particular relational database system is required and the system may be implemented using any of a variety of open source or proprietary platforms known in the art, such as Oracle Database, IBM DB2, IBM Informix, MySQL, Microsoft SQL Server, PostgreSQL, Amazon AWS, and the like.

Referring to FIGS. 4a-c, each card may have one or more associated tags, used for searching, described further below, and organizing a user's cards. Tags are user-defined descriptive phrases that categorize cards. The same tag may be applied to one or more cards. Tags are one of the more powerful mechanisms in the Contact Data Engine, mainly because of the way they uniquely identify a Card in such a way as to be easily remembered. But they may also be used to identify a collection of Cards related by industry, proximity, personal relation or any other criteria. One very specialized use of Tags is as a conference code. Business owners frequently attend trade shows, conferences and other such meetings with professionals in like industries. There is great value in maintaining these relationships after these events are over. Each Card Owner attending such an event would be given a unique Tag (some memorable word or phrase as it relates to the event) which can then be used as a quick lookup using the Contact Data Engine.

For example, as shown in FIG. 4b, forty-five members of the MA Realtors Association attend the annual Realtor's conference. Each member has their Card in the Busidex platform. As part of the conference, each member is given the Tag “MARealtors2014”. From that point on, any time a member wants to contact someone who attended that conference, they simply search for that Tag using the Contact Data Engine without having to remember names or hunt through scraps of paper looking for phone numbers.

Another unique usage for Tags within the Busidex platform is for creating a Membership Directory. The Membership Directory can have 1 . . . n levels of depth by combining Tags. For example, using the Tag “Dynex” someone can look up all employees of the Dynex company. Adding “Marketing” to the Tag search filters the list down to those employees working in the Marketing department. This filter can go as deep as is desired simply by adding Tag filters. This works by using a logical AND to combine Tag filters. In the Dynex example above, only cards with the Tags “Dynex” AND “Marketing” are shown.

Referring to FIG. 4c (also shown in FIG. 3), the data structure and relationship between the Tag and the Contact that makes this possible is a simple one-to-many relationship, where each tag is unique, thereby allowing for a Dictionary lookup at runtime.

Referring to FIGS. 5 and 6, each card may be assigned a Card Owner. A Card Owner is defined as the person who is referenced by the contact information associated with the card i.e. Address, Phone Number, and/or Email. Once a card is owned, only the Card Owner may edit that particular card.

Referring to FIGS. 7 and 8, a user's cards are stored in a personal collection, called MyBusidex. Users can add cards to their personal collection, but may only edit Cards that they own or that they uploaded and are not owned. The collection contains references to cards, but not the actual card, which is unique to the system. When a card is updated, all references to that Card in any MyBusidex collections see the updates immediately. A user may add their own personal notes to a card, but these notes are not propagated through the system and remain private to the user that created the note.

Referring to FIG. 9, users may share cards to other users. When a card is shared, an instance of a shared card is created and transmitted to the recipient. The recipient may choose to accept or decline the card. If accepted, an instance of the card (with a reference to the original card) is created and stored in the recipient's MyBusidex collection.

Referring to FIG. 10, the system and method provides a screen for a user to select one or more cards to share. The user, via a graphical interface, my select as many cards in their own collection to share as are available.

Referring to FIG. 11, the system and method provides for a user to enter an email address of a person with whom to the share the selected cards from the step shown in FIG. 10.

Referring to FIG. 12, the recipient logs into the system, where they receive a shared card notification.

Referring to FIG. 13, the recipient may accept or decline the shared cards. If accepted, the card will be added to the recipient's cards, i.e. MyBusidex collection.

Referring to FIG. 14, the user may create, update and delete a relationship for each card in their collection. Card Owners may select cards in their MyBusidex collection to be ‘related’ or associated with their own card. Related cards, which are shared, will show up in the card details for all those with whom the cards are shared. For example, User A is a Real Estate Agent. User A may choose to upload two loan officer's cards and a lawyer's card to their MyBusidex collection. User A marks those cards as Related to his own card. User A has a client (User B), and shares the related cards with User B. When User B views User A's card in their MyBusidex collection, the related cards will appear along with User A's card. The related cards only show in User B's MyBusidex collection, because although they are marked as related, they were only shared with this User B. When other clients view User A's card in their Busidex collection, they do not see the related cards, since User A did not share those cards with them. The Busidex Data Service recognizes when to show the list of related cards to a user by locating a matching record in Card Relation table

Referring to FIG. 15, a user may search through their MyBusidex collection and all cards that are searchable. Cards are considered “searchable” if they have a Card Owner; otherwise they are not publicly visible. If a user is logged in, the scope of a Search includes all cards in their MyBusidex collection as well as all Searchable Cards. Search criteria may include tags, names, phone numbers, and/or company or employer name. Because geo-location is also an attribute of a Card, it is possible to limit a search to a distance radius or defined geographic area, such as a state, city, or metropolitan area.

Referring to FIG. 16, the system and method provides for a user to manually create a card using an online editor. Using the online form, users can choose the card background color, font color and enter card attributes while getting immediate visual feedback as to what the card will look like. The system will save the HTML markup used to display the card and store it on the card record. Cards may also be imported using scanners or common file formats, such as CSV and other delimited formats.

Referring to FIGS. 17-22, users can organize their cards into groups, or Busigroups. One card can be in zero or many Busigroups. A Busigroup can contain as many cards as the user wants. Busigroups may also be shared between users.

Referring to FIGS. 17 and 18, a user first creates the group by selecting an option to create a group and then assigning the group a name. The user then adds cards to the group via a graphical user interface, as shown in FIG. 19.

Referring to FIG. 20, the user then may view the group that they just created. The user may then share the group with other users by sending an invitation as described above with individual cards.

Referring to FIGS. 21 and 22, a user may share a card with another person that does not have an account with Busidex Data Services. Users can invite business owners that do not have an account by adding a card of the business owner to the Busidex collection and then sending an invitation via email to the email address supplied for that card.

Therefore, it can be seen the method and system described herein provides a unique approach to sharing and propagating contact information among users that is easy to update and maintain.

It would be appreciated by those skilled in the art that various changes and modifications can be made to the illustrated embodiments without departing from the spirit of the present invention. All such modifications and changes are intended to be within the scope of the present invention except insofar as limited by the appended claims.

What is claimed is:

1. A contact data management system in a networked computers environment, comprising:
a data storage, a processor, and a program memory;
a user interface configured to display and input a plurality of cards having contact information, the user interface having user interface logic operative to cause the processor and memory to display the user interface for a user;
a database configured to store and retrieve cards on the data storage, the database having logic operative to cause the processor and memory to create, read, update and delete contact information in the data storage;
each card including a Card Owner field, designating the owner of the card; and
each card including one or more relationships with other cards in the database.

2. The contact data management system of claim 1, further including a plurality of user accounts, each user account including a collection of cards.

3. The contact data management system of claim 2, further including user-definable tags that users may assigned to each card in their collection.

4. The contact data management system of claim 2, wherein each user may create notes that may be connected to each card.

5. The contact data management system of claim 2, wherein each user may create a group of cards and share them with other users.

6. The contact data management system of claim 1, wherein each user may share a card in their collection with another user.

7. A computer-implemented method of managing contact data on a networked computer environment, the networked computer environment including a data storage, a processor, and a program memory, the method comprising:
providing a user interface configured to display and input a plurality of cards having contact information, the user interface having user interface logic operative to cause the processor and memory to display a user interface for a user;
creating a database configured to store and retrieve cards on the data storage; the database having logic operative to cause the processor and memory to create, read, update and delete contact information in the data storage;
defining each card to include a Card Owner field, designating the owner of the card; and
defining each card to include one or more relationships with other cards in the database.

8. The computer-implemented method of claim 7, creating a plurality of user accounts, each user account including a collection of cards.

9. The computer-implemented method of claim 8, creating user-definable tags that users may assigned to each card in their collection.

10. The computer-implemented method of claim 8, creating user-defined notes that may be connected to each card.

11. The computer-implemented method of claim 8, creating and sharing user-defined groups of cards with other users.

12. The computer-implemented method of claim 7, sharing a card in a user's collection with another user.
